(19) United States
(12) Patent Application Publication
(10) Pub. No.: US 2022/0416243 A1
(43) Pub. Date: Dec. 29, 2022

(54) Electrode for Redox Flow Battery and Production Method Thereof

(71) Applicants: Aion Co., Ltd., Osaka (JP); National University Corporation Gunma University, Gunma (JP)

(72) Inventors: Hidehiko Tsukada, Koga-shi, lbaraki (JP); Natsumi Tomita, Koga-shi, lbaraki (JP); Hirokazu Ishitobi, Maebashi-shi, Gunma (JP); Soshi Shiraishi, Maebashi-shi, Gunma (JP); Honoka Doki, Maebashi-shi, Gunma (JP); Nobuyoshi Nakagawa, Maebashi-shi, Gunma (JP)

(21) Appl. No.: 17/780,106

(22) PCT Filed: Nov. 24, 2020
(86) PCT No.: PCT/JP2020/043589

§ 371 Date: May 26, 2022

(30) Foreign Application Priority Data
Nov. 27, 2019 (JP) 2019-213813

(51) Int. Cl. H01M 4/583; H01M 8/18; H01M 4/04; H01M 4/36

(52) U.S. Cl. CPC H01M 4/583; H01M 8/188; H01M 4/0471; H01M 4/366; H01M 2004/021

(57) ABSTRACT

An electrode for a redox flow battery, including a plate-shaped carbon electrode material, in which uniform consecutive macropores are formed in a three-dimensional network form and contact interface between carbon particles does not exist, in which: an average macropore diameter of the carbon electrode material is in a range of from 6 μm to 35 μm; an interplanar distance of (002) planes of a graphite crystallite in the carbon electrode material is in a range of from 0.33 nm to 0.40 nm; and a crystallite size of a graphite crystallite in a c-axis direction in the carbon electrode material is in a range of from 0.9 nm to 8.5 nm.

### TECHNICAL FIELD

The present invention relates to an electrode for redox flow batteries, which are one of flow-type batteries and cells, and a production method thereof. In particular, the invention relates to an electrode for redox flow batteries having a high maximum power density of a battery and a low pressure drop at the time of supplying an electrolyte solution, and a production method thereof. As used herein, the “activation treatment” refers to a treatment of heating a plate-shaped carbonized product to a predetermined temperature and then supplying an activating gas to the plate-shaped carbonized product to form micropores in the plate-shaped carbonized product to make the plate-shaped carbonized product porous and increase the active surface area. The “air oxidation treatment” refers to a treatment of heating a plate-shaped carbonized product to a predetermined temperature in the air to form micropores in the plate-shaped carbonized product to make the plate-shaped carbonized product porous, increase the active surface area, and introduce oxygen functional groups, which serve as reaction active sites, onto the surface of the plate-shaped carbonized product. The present international application claims priority from Japanese Patent Application No. 2019-213813 filed on Nov. 27, 2019, and the entire contents of Japanese Patent Application No. 2019-213813 are incorporated in the present international application.

### BACKGROUND ART

In recent years, among flow-type batteries and cells, a vanadium redox flow battery (VRFB: Vanadium Redox Flow Battery, hereinafter simply referred to as a redox flow battery) has been attracting attention as a power storage battery. This redox flow battery is a battery in which an electrolyte solution containing an active material is supplied to an electrode by a pump, and which adjusts the power fluctuation of renewable energy such as solar and wind power, and stores the power from renewable energy. The redox flow battery includes an electrolytic cell whose inside is separated into a positive electrode chamber and a negative electrode chamber by a separator through which hydrogen ions permeate, a positive electrolyte tank for storing a positive electrolyte solution, a negative electrolyte tank for storing a negative electrolyte solution, a pump for circulating the electrolyte solution between the tank and the electrolytic cell, and the like. Then, the positive electrolyte solution is circulated between the positive electrolyte tank and the positive electrode chamber, and the negative electrolyte solution is circulated between the negative electrolyte tank and the negative electrode chamber, and charging are discharging are carried out by making a redox reaction proceed on each of the electrodes placed in the positive electrode chamber and the negative electrode chamber.

Conventionally, as an electrode for a redox flow battery, a carbon fiber assembly composed of carbon felt, carbon paper, carbon cloth, or the like has been used (see, for example, Patent Documents 1 and 2).

[Patent Document 1] Japanese Patent Application Laid-Open (JP-A) No. 2017-010809 (claim 8)

[Patent Document 2] Japanese Patent Application Laid-Open (JP-A) No. 2018-147595 (claim 1, paragraph [0002])

### SUMMARY OF INVENTION

### Technical Problem

For a redox flow battery used for storing renewable energy such as solar and wind power, an electrode is required that can be charged and discharged with a large current even when the output of the renewable energy fluctuates within a short period due to the weather. However, since each of the electrodes for redox flow batteries described in Patent Documents 1 and 2 is a carbon fiber assembly composed of a fiber stacked material in which carbon fibers are overlapped, the pressure drop (fluid resistance) at the time of supplying an electrolyte solution is high, and the activity of the electrode material is low. Therefore, the improvement of the current output at the power transmission end of the redox flow battery, that is, the improvement of the maximum power density of the battery is limited, and there is still a problem to be solved as an electrode for a redox flow battery.

It is an object of the invention to provide an electrode for a redox flow battery having a high maximum power density of the battery and a low pressure drop at the time of supplying an electrolyte solution, and a method of producing such an electrode.

### Solution to Problem

A first aspect of the invention is an electrode for a redox flow battery, comprising one plate-shaped carbon electrode material or two or more stacked plate-shaped carbon electrode materials, in which uniform consecutive macropores are formed in a three-dimensional network form and contact interface between carbon particles does not exist, wherein: an average macropore diameter of the carbon electrode material is in a range of from 6 μm to 35 μm; an interplanar distance of (002) planes of a graphite crystallite in the carbon electrode material is in a range of from 0.33 nm to 0.40 nm; a crystallite size of a graphite crystallite in a c-axis direction in the carbon electrode material is in a range of from 0.9 nm to 8.5 nm; and a thickness of the electrode is in a range of from 0.4 mm to 0.8 mm.

A second aspect of the invention is the electrode for a redox flow battery according to the first aspect, wherein: a BET specific surface area of the carbonized product according to a nitrogen adsorption method at 77 K is in a range of from 100 m²/g to 1,500 m²/g; a micropore volume of the carbonized product is in a range of from 0.05 ml/g to 0.70 ml/g; an interplanar distance of (002) planes of a graphite crystallite in the carbonized product is in a range of from 0.33 nm to 0.40 nm; and a crystallite size of a graphite crystallite in a c-axis direction in the carbonized product is in a range of from 0.9 nm to 8.5 nm.

A third aspect of the invention is a method of producing an electrode for a redox flow battery, the method comprising: a step of cutting a block of a porous phenol resin, in which uniform consecutive macropores having an average macropore diameter in a range of from 4 μm to 70 μm are formed in a three-dimensional network form, into a plate-shaped body; a step of raising a temperature of the plate-shaped body from room temperature to a range of from 800° C. to 1,000° C. under an inert gas atmosphere, and holding the plate-shaped body at the raised temperature under an inert gas atmosphere to carry out a carbonization treatment, thereby obtaining a plate-shaped carbonized product; a step of raising a temperature of the plate-shaped carbonized product from room temperature to a range of from 1,100° C. to 2,500° C., and holding the plate-shaped carbonized product at the raised temperature under an inert gas atmosphere to carry out a high-temperature heat treatment; and a step of raising a temperature of the plate-shaped carbonized product, on which the high-temperature heat treatment has been carried out, from room temperature to a range of from 350° C. to 600° C. in air, and holding the plate-shaped carbonized product at the raised temperature in air to carry out an air oxidation treatment, thereby obtaining a plate-shaped carbon electrode material.

A fourth aspect of the invention is a method of producing an electrode for a redox flow battery, the method comprising: a step of cutting a block of a porous phenol resin, in which uniform consecutive macropores having an average macropore diameter in a range of from 4 μm to 70 μm are formed in a three-dimensional network form, into a plate-shaped body; a step of raising a temperature of the plate-shaped body from room temperature to a range of from 800° C. to 1,000° C. under an inert gas atmosphere, and holding the plate-shaped body at the raised temperature under an inert gas atmosphere to carry out a carbonization treatment, thereby obtaining a plate-shaped carbonized product; a step of raising a temperature of the plate-shaped carbonized product from room temperature to a range of from 1,100° C. to 2,500° C., and holding the plate-shaped carbonized product at the raised temperature under an inert gas atmosphere to carry out a high-temperature heat treatment; and a step of carrying out an activation treatment on the plate-shaped carbonized product, on which the high-temperature heat treatment has been carried out, so that an activation yield is in a range of from 50% to 90%, thereby obtaining a plate-shaped carbon electrode material.

A fifth aspect of the invention is the method according to the fourth aspect, wherein the activation treatment is carried out by raising a temperature of the plate-shaped carbonized product, on which the high-temperature heat treatment has been carried out, from room temperature to a range of from 800° C. to 1,000° C. under an inert gas atmosphere, and holding the plate-shaped carbonized product at the raised temperature under a carbon dioxide gas flow.

A sixth aspect of the invention is a redox flow battery using the electrode according to the first or second aspect.

### Advantageous Effects of Invention

The electrode for a redox flow battery according to the first aspect of the invention comprises one or two or more plate-shaped carbon electrode materials, in which uniform consecutive macropores are formed in a three-dimensional network form and contact interface between carbon particles does not exist, wherein: an average macropore diameter of the carbon electrode material is in a range of from 6 μm to 35 μm; an interplanar distance of (002) planes of a graphite crystallite in the carbon electrode material is in a range of from 0.33 nm to 0.40 nm; a crystallite size of a graphite crystallite in a c-axis direction in the carbon electrode material is in a range of from 0.9 nm to 8.5 nm; and a thickness of the electrode is in a range of from 0.4 mm to 0.8 mm. As a result, the electrode has a high maximum power density of the battery and a low pressure drop at the time of supplying an electrolyte solution by a pump in the battery, as compared to a conventional electrode composed of a fiber stacked material in which carbon fibers such as carbon felt, carbon paper, and carbon cloth are stacked, that is, the electrode has properties suitable for an electrode for a redox flow battery.

The electrode for a redox flow battery according to the second aspect of the invention is the electrode for a redox flow battery according to the first aspect, wherein: a BET specific surface area of the carbonized product according to a nitrogen adsorption method at 77 K is in a range of from 100 m²/g to 1,500 m²/g; a micropore volume of the carbon electrode material is in a range of from 0.05 ml/g to 0.70 ml/g; an interplanar distance of (002) planes of a graphite crystallite in the carbon electrode material is in a range of from 0.33 nm to 0.40 nm; and a crystallite size of a graphite crystallite in a c-axis direction in the carbon electrode material is in a range of from 0.9 nm to 8.5 nm. As a result, the electrode has a high maximum power density of the battery and a low pressure drop at the time of supplying an electrolyte solution by a pump in the battery, as compared to a conventional electrode composed of a fiber stacked material in which carbon fibers such as carbon felt, carbon paper, and carbon cloth are stacked, that is, the electrode has properties suitable for an electrode for a redox flow battery.

The method according to the third aspect of the invention comprises: cutting a block of a porous phenol resin, in which uniform consecutive macropores having an average macropore diameter in a range of from 4 μm to 70 μm are formed in a three-dimensional network form, into a plate-shaped body; raising a temperature of the plate-shaped body from room temperature to a range of from 800° C. to 1,000° C. under an inert gas atmosphere, and holding the plate-shaped body at the raised temperature under an inert gas atmosphere to carry out a carbonization treatment, thereby obtaining a plate-shaped carbonized product; raising a temperature of the plate-shaped carbonized product from room temperature to a range of from 1,100° C. to 2,500° C., and holding the plate-shaped carbonized product at the raised temperature under an inert gas atmosphere to carry out a high-temperature heat treatment; and raising a temperature of the plate-shaped carbonized product, on which the high-temperature heat treatment has been carried out, from room temperature to a range of from 350° C. to 600° C. in air, and holding the plate-shaped carbonized product at the raised temperature in air to carry out an air oxidation treatment. In this case, the plate-shaped body cut from the block of the porous phenol resin is treated through the carbonization treatment, the high-temperature heat treatment, and the air oxidation treatment, the obtained products are keeping the structure in which uniform consecutive macropores are formed in a three-dimensional network form, and resulting in the final product as the electrodes of the plate-shaped carbonized product. By the high-temperature heat treatment and the air oxidation treatment on the plate-shaped carbonized product, the crystallinity of the carbon matrix is increased, the interplanar distance of (002) planes of the graphite crystallite becomes a predetermined value, and the BET specific surface area of the plate-shaped carbonized product is increased. As a result, this production method makes the plate-shaped carbonized product a highly active material structure, and can produce an electrode that enables a high battery power corresponding to charging and discharging of the redox flow battery with a large current within a short period.

The method according to the fourth aspect of the invention comprises: cutting a block of a porous phenol resin, in which uniform consecutive macropores having an average macropore diameter in a range of from 4 μm to 70 μm are formed in a three-dimensional network form, into a plate-shaped body; raising a temperature of the plate-shaped body from room temperature to a range of from 800° C. to 1,000° C. under an inert gas atmosphere, and holding the plate-shaped body at the raised temperature under an inert gas atmosphere to carry out a carbonization treatment, thereby obtaining a plate-shaped carbonized product; raising a temperature of the plate-shaped carbonized product from room temperature to a range of from 1,100° C. to 2,500° C., and holding the plate-shaped carbonized product at the raised temperature under an inert gas atmosphere to carry out a high-temperature heat treatment; and carrying out an activation treatment on the plate-shaped carbonized product, on which the high-temperature heat treatment has been carried out, so that an activation yield is in a range of from 50% to 90%. Here, the “activation yield” is the ratio of change in the sample mass due to the activation treatment, which is represented by the following equation.

Activation yield (%)=(mass of sample after activation/mass of sample before activation)×100%

In this case, the plate-shaped body cut from the block of the porous phenol resin is treated through the carbonization treatment, the high-temperature heat treatment, and the activation treatment, the obtained products are keeping the structure in which uniform consecutive macropores are formed in a three-dimensional network form, and resulting in the final products as the electrodes of the plate-shaped carbonized product. By the high-temperature heat treatment on the plate-shaped carbonized product, the interplanar distance of (002) planes of the graphite crystallite becomes a predetermined value, and by the activation treatment, micropores are mainly formed in the carbon material, so that the BET specific surface area of the plate-shaped carbonized product is further increased, and the active surface area is further increased. As a result, this production method makes the plate-shaped carbonized product a further highly active material structure, and reduces the reaction (kinetic) resistance of the electrode, and can produce an electrode that enables a high battery power corresponding to charging and discharging of the redox flow battery with a large current within a short period.

In the method according to the fifth aspect of the invention, the activation treatment is carried out by raising a temperature of the plate-shaped carbonized product, on which the high-temperature heat treatment has been carried out, from room temperature to a range of from 800° C. to 1,000° C. under an inert gas atmosphere, and holding the plate-shaped carbonized product at the raised temperature under a carbon dioxide gas flow. In this case, when the carbon dioxide activation treatment is carried out, micropores are formed. As a result, this production method has the advantage that the BET specific surface area is increased due to the micropores.

The redox flow battery according to the sixth aspect of the invention has, due to the use of the electrode according to the first or second aspect, a high reaction current density and a high maximum power density of the battery, as compared to a redox flow battery using a conventional electrode composed of a fiber stacked material in which carbon fibers such as carbon felt, carbon paper, and carbon cloth are stacked.

### BRIEF DESCRIPTION OF DRAWINGS

FIG. 1 is scanning electron microscope (SEM) images of a plate-shaped carbonized product of Example 1. FIG. 1(a) is an image at a magnification of 5,000 times, FIG. 1(b) is an image at a magnification of 2,000 times, and FIG. 1(c) is an image at a magnification of 500 times.

FIG. 2 is a SEM image of a porous phenol resin of Example 1.

FIG. 3 is a perspective diagram of a cell assembly including a plate-shaped carbonized product as an electrode.

FIG. 4 is a schematic configuration diagram of a current-voltage (I-V) measurement test system.

FIG. 5 shows current-voltage curves and power curves of batteries using the plate-shaped carbonized products of Examples 2 and 6 and the carbon papers of Comparative Examples 3 to 5.

FIG. 6 shows current-voltage curves and power curves of batteries using plate-shaped carbonized products of Examples 1, 2, and 10, and Comparative Example 1.

FIG. 7 shows current-voltage curves and power curves of batteries using the plate-shaped carbonized products of Examples 3, 4, and 6.

FIG. 8 shows current-voltage curves and power curves of batteries using the plate-shaped carbonized products of Examples 1, 5, and 9, and Comparative Example 2.

FIG. 9 shows current-voltage curves and power curves of batteries using the plate-shaped carbonized products of Examples 1 and 7, and Comparative Examples 6 and 7.

FIG. 10 shows current-voltage curves and power curves of batteries using the plate-shaped carbonized products of Examples 4 and 8.

FIG. 11 shows current-voltage curves and power curves of batteries using the plate-shaped carbonized products of Examples 1, 11, and 12.

FIG. 12 shows nitrogen adsorption desorption isotherms of plate-shaped carbonized products according to different treatment methods.

FIG. 13 shows nitrogen adsorption desorption isotherms of plate-shaped carbonized products according to different treatment methods.

FIG. 14 shows nitrogen adsorption desorption isotherms of plate-shaped carbonized products according to different treatment methods.

### DESCRIPTION OF EMBODIMENTS

Next, the methods of producing electrodes for redox flow batteries of first and second embodiments of the invention will be respectively described. The first and second embodiments differ in that the treatment step after the high-temperature heat treatment is an air oxidation treatment or a carbon dioxide activation treatment.

### First Embodiment

[Method of Producing Electrode for Redox Flow Battery]

In the method of producing an electrode for a redox flow battery of the first embodiment, a block of a porous phenol resin, in which consecutive macropores having an average macropore diameter in a range of from 4 μm to 70 μm are formed in a three-dimensional network form, is cut into a plate-shaped body. The temperature of the plate-shaped body is raised from room temperature to a range of from 800° C. to 1,000° C. under an inert gas atmosphere, and the plate-shaped body is held at the raised temperature under an inert gas atmosphere to carry out a carbonization treatment, thereby obtaining a plate-shaped carbonized product. The temperature of the plate-shaped carbonized product is raised from room temperature to a range of from 1,100° C. to 2,500° C. under an inert gas atmosphere, and the plate-shaped carbonized product is held at the raised temperature under an inert gas atmosphere to carry out a high-temperature heat treatment. Next, the temperature of the plate-shaped carbonized product, on which the high-temperature heat treatment has been carried out, is raised from room temperature to a range of from 350° C. to 600° C. in air, and the plate-shaped carbonized product is held at the raised temperature in air to carry out an air oxidation treatment.

Next, the production method of the first embodiment will be described in detail for each step.

(a) Production of Block of Porous Phenol Resin and Step of Cutting Block into Plate-Shaped Body

(a-1) Production of Block of Porous Phenol Resin

The block of a porous phenol resin is produced by the following method. First, a phenol resin and a polyvinyl alcohol (PVA) are mixed. In the mixing of the phenol resin and the PVA, in order to uniformly mix both the components, for example, it is preferable to disperse a liquid phenol resin in water, dissolve the PVA in water serving as a dispersion medium, and mix both the liquids by stirring. At the time of the mixing, it is preferable to add a pore-forming agent such as rice starch, wheat starch, corn starch, or potato starch, and a cross-linking agent such as a formaldehyde aqueous solution, butylaldehyde, or glutaraldehyde, and further add a catalyst such as maleic acid, hydrochloric acid, or sulfuric acid in order to cure the mixed liquid.

Subsequently, water is added to the mixture and mixed, and the obtained reaction liquid is cast into a block-shaped mold made of synthetic resin, heated, and reacted for a predetermined time. The obtained reaction product is taken out from the mold, washed with water to remove the pore-forming agent and unreacted substances, and then dried. By this production method, a block of a porous phenol resin, in which consecutive macropores having an average macropore diameter in a range of from 4 μm to 120 μm are formed in a three-dimensional network form, can be obtained. In the method of producing a phenol resin block of the present embodiment, it is possible to adjust the diameter of the uniform consecutive fine pores within a desired size by uniformly mixing the pore-forming agent in the phenol resin, and selecting the type and amount of the pore-forming agent, and the temperature. The range of the average pore diameter of from 4 μm to 70 μm of the consecutive macropores of the precursor formed in a three-dimensional network form is determined in view of the pressure drop (fluid resistance) at the time of supplying the electrolyte solution, the transport of the active material, the reaction specific surface area, and the kinetic (reaction) resistance, when the precursor is made into an electrode. If the average pore diameter of the consecutive macropores of the precursor is less than the above lower limit value, the pressure drop at the time of supplying the electrolyte solution cannot be reduced and the transport of the active material is not promoted, when the precursor is made into an electrode. If exceeding the upper limit value, the reaction specific surface area is reduced and the kinetic (reaction) resistance is increased. The average macropore diameter is measured using a mercury porosimeter.

(a-2) Step of Cutting Block of Porous Phenol Resin into Plate-Shaped Body

The size of the plate-shaped body cut out from the block of a porous phenol resin is not particularly limited. For example, the block is cut into a cuboid having a length of 30 mm and a width of 50 mm with a diamond saw. After cutting into the cuboid, for example, the cuboid is cut into a plate-shaped body having a thickness in the range of from 0.5 mm to 1.0 mm with a diamond saw. The shape, size, and thickness of the cut out plate-shaped body are determined according to the shape and size of the electrode for the redox flow battery. The thickness of the electrode for the redox flow battery is preferably from 0.4 mm to 0.8 mm from the viewpoint of the reaction area, pressure drop, ohmic resistance, and cost. This is because if the thickness of the electrode is small, the maximum power is low, and if the thickness of the electrode is increased, the ohmic resistance increases, and the electrode is uneconomical from the viewpoint of the material cost. Taking into consideration the shrinkage ratio including carbonization, a plate-shaped body is cut out from the block so as to have a thickness suitable for the electrode.

(b) Production Step of Plate-Shaped Carbonized Product

Next, the cut out plate-shaped body composed of the porous phenol resin is placed in a heat treatment furnace. It is preferable to use a horizontal tubular electric furnace as the heat treatment furnace. Subsequently, the atmosphere inside the furnace is replaced with an inert gas, the temperature of which is raised from room temperature to a range of from 800° C. to 1000° C., preferably from 800° C. to 900° C., and the plate-shaped body is held under the inert gas atmosphere at the raised temperature to carry out a heat treatment. After the heat treatment, it is preferable to slowly cool the electric furnace to room temperature. The temperature rise rate is preferably from 5° C./min to 20° C./min, and the time for holding at the raised temperature is preferably from 0.5 hour to 2 hours. By carrying out the heat treatment under the above conditions, the plate-shaped body cut out from the block is carbonized to obtain a plate-shaped carbonized product. As the inert gas, a gas such as nitrogen, argon or helium is used.

(c) High-Temperature Heat Treatment Step of Plate-Shaped Carbonized Product

Next, the plate-shaped carbonized product is subjected to a high-temperature heat treatment. For the high-temperature heat treatment, it is preferable to use the heat treatment furnace used in the above-mentioned carbonization treatment, and it is preferable to use a horizontal tubular electric furnace as the heat treatment furnace. After the plate-shaped carbonized product is placed in the furnace, the atmosphere inside the furnace is replaced with an inert gas, the temperature of which is raised from room temperature to a range of from 1,100° C. to 2500° C., preferably from 1,200° C. to 2,200° C., and the plate-shaped carbonized product is held under the inert gas atmosphere at the raised temperature to carry out a high-temperature heat treatment. After the high-temperature heat treatment, it is preferable to slowly cool the electric furnace to room temperature. The rate of temperature rise during the high-temperature heat treatment is preferably from 5° C./min to 20° C./min, and the time for holding at the raised temperature is preferably from 0.5 hour to 2 hours. By carrying out the high-temperature heat treatment under the above conditions, impurities of the carbonized product are removed and the crystallinity of the carbon matrix is increased. As the inert gas, a gas such as nitrogen, argon, or helium is used.

The raised temperature for the high-temperature heat treatment is specified within the above range because if the temperature is less than the lower limit value, the crystallinity of the carbon matrix is not sufficiently improved, and if exceeding the upper limit value, the BET specific surface area of the plate-shaped carbonized product is less likely to be increased in the subsequent air oxidation treatment step. Further, the rate of temperature rise for the high-temperature heat treatment is specified within the above range because if the rate is less than the lower limit value, the time required for the high-temperature heat treatment tends to be long, and if exceeding the upper limit value, the crystallinity of the carbon matrix is less likely to be sufficiently improved.

(d) Air Oxidation Treatment Step of High-Temperature Heat-Treated Plate-Shaped Carbonized Product

The air oxidation treatment is carried out by placing the high-temperature heat-treated plate-shaped carbonized product in a muffle furnace. While the high-temperature heat-treated plate-shaped carbonized product is placed in a muffle furnace in the air, the temperature of the muffle furnace is raised from room temperature to a range of from 350° C. to 600° C., preferably from 400° C. to 500° C., and the high-temperature heat-treated plate-shaped carbonized product is held at the raised temperature. Here, the high-temperature heat-treated plate-shaped carbonized product is preferably held at the raised temperature in the air for from 1 to 24 hours so that the mass decrease ratio of the carbonized product is from 1.0% to 25.0%, preferably from 1.8% to 20.8%. By carrying out the air oxidation treatment under the above conditions, micropores are formed in the plate-shaped carbonized product, the plate-shaped carbonized product is made porous, the BET specific surface area is increased, and an oxygen functional group is introduced onto the surface of the plate-shaped carbonized product to form a reaction active site. As a result, the production method of the first embodiment makes the plate-shaped carbonized product a highly active material structure, and can produce an electrode that enables a high battery power corresponding to charging and discharging of the redox flow battery with a large current within a short period.

The raised temperature for the air oxidation treatment of the plate-shaped carbonized product is specified within the above range because if the temperature is less than the lower limit value, the plate-shaped carbonized product is not sufficiently oxidized, and if exceeding the upper limit value, the mass decrease ratio is excessively increased, and there is a problem that the plate-shaped carbonized product is too oxidized to maintain the shape and oxygen at the surface is thermally decomposed. The mass decrease ratio is specified within the above range because if the ratio is less than the lower limit value, an electrode having a sufficient BET specific surface area is less likely to be obtained, and if exceeding the upper limit value, the plate-shaped carbonized product may be too oxidized to maintain the shape.

### Second Embodiment

[Production Method of Electrode for Redox Flow Battery]

(a) production of a block of a porous phenol resin and a step of cutting the block into a plate-shaped body, (b) a production step of a plate-shaped carbonized product, and (c) a high-temperature heat treatment step of a plate-shaped carbonized product in the production method of an electrode for a redox flow battery of the second embodiment are the same as those in the production method of the first embodiment.

In the production method of an electrode for a redox flow battery of the second embodiment, a carbon dioxide activation treatment step is carried out after (c) a high-temperature heat treatment step of a plate-shaped carbonized product.

(e) Carbon Dioxide Activation Treatment Step of High-Temperature Heat-Treated Plate-Shaped Carbonized Product

The carbon dioxide activation treatment is carried out by placing the high-temperature heat-treated plate-shaped carbonized product in a horizontal tubular furnace. The temperature of the high-temperature heat-treated plate-shaped carbonized product is raised to a range of from 800° C. to 1,000° C. under an inert gas atmosphere in the horizontal tubular electric furnace.

Next, the introduction of the inert gas is stopped and a carbon dioxide gas is introduced. The high-temperature heat-treated plate-shaped carbonized product is held at the raised temperature under a carbon dioxide gas flow, so that the activation yield is preferably from 50% to 90%, more preferably from 55% to 85%. The holding time is preferably in the range of from 0.5 hour to 12 hours, more preferably from 1 hour to 10 hours.

In the carbon dioxide activation treatment, micropores are formed in the carbon matrix by the reaction represented by the following formula.

C+CO₂→2CO↑

That is, by the carbon dioxide activation treatment after the high-temperature heat treatment of the plate-shaped carbonized product, micropores are formed in the carbon on the surface of the carbon material, so that the BET specific surface area of the plate-shaped carbonized product is further increased and the reaction surface area is further increased. Further, by carrying out the activation treatment under a carbon dioxide gas atmosphere, micropores are easily developed. The micropores here indicates a range of less than 2 nm. As a result, the production method of the second embodiment makes the plate-shaped carbonized product a further highly active material structure, and reduces the kinetic (reaction) resistance of the electrode, and can produce an electrode that enables a high battery power corresponding to charging and discharging of the redox flow battery with a large current within a short period.

[Electrode for Redox Flow Battery]

The electrode for a redox flow battery produced by each of the methods of the first and second embodiments includes a plate-shaped carbonized product. In this carbonized product, uniform consecutive macropores are formed in a three-dimensional network form, and contact interface between carbon particles does not exist. In other words, the plate-shaped carbonized product is composed of seamless carbon in which contact interface between carbon particles does not exist, and has a three-dimensional network structure of consecutive macropores that are homogeneous and uniform in the thickness direction and in the in-plane direction.

Regarding the consecutive pores, the average macropore diameter of the plate-shaped carbonized product is in the range of from 6 μm to 35 μm, preferably in the range of from 6 μm to 25 μm. If the average macropore diameter is less than 6 μm, when the plate-shaped carbonized product is made into an electrode, the pressure drop at the time of supplying an electrolyte solution by a power pump cannot be reduced, and the transport of the active material is not promoted. If the average macropore diameter exceeds 35 μm, when the plate-shaped carbonized product is made into an electrode, the reaction specific surface area is decreased and the kinetic (reaction) resistance is increased. The average pore diameter of the plate-shaped carbonized product is measured by a mercury porosimeter. The BET specific surface area of the plate-shaped carbonized product is determined according to the BET equation from a nitrogen adsorption desorption isotherm obtained by carrying out a vacuum treatment at 120° C. for 3 hours as a pretreatment, changing the relative pressure at a temperature of 77K, and measuring the nitrogen adsorption amount at that time, using a gas analyzer BELSORP28A, manufactured by Microtrac BEL Corp.

In addition to the above, the BET specific surface area of the plate-shaped carbonized product is in the range of from 100 m²/g to 1,500 m²/g, preferably in the range of from 600 m²/g to 1,500 m²/g. If the BET specific surface area is less than 100 m²/g, when the plate-shaped carbonized product is made into an electrode, a sufficient current output cannot be obtained because the BET specific surface area is insufficient.

Further, the micropore volume is in the range of from 0.05 ml/g to 0.70 ml/g, preferably in the range of from 0.2 ml/g to 0.40 ml/g. The micropore volume is specified within the above range because if it is less than the lower limit value, a sufficient volume cannot be secured, and if it exceeds the upper limit value, there is a problem that the bulk density of the electrode is lowered. The micropore volume is determined by the Dubinin-Radushkevich (DR) method.

The interplanar distance of (002) planes of a graphite crystallite in the plate-shaped carbonized product is in the range of from 0.33 nm to 0.40 nm, preferably in the range of from 0.34 nm to 0.39 nm. If the interplanar distance exceeds the upper limit value, the crystallinity is not sufficient and the electric conductivity is inferior. It is known that the interplanar distance of (002) planes of a graphite having a sufficiently high crystallinity is 0.3354 nm, and there is no carbon material having an interplanar distance of (002) planes that is less than the lower limit value. The crystallite size of a graphite crystallite in a c-axis direction in the plate-shaped carbonized product is in the range of from 0.9 nm to 8.5 nm. If the crystallite size is less than the lower limit value, the crystallinity of the carbon matrix is insufficient, and if it exceeds the upper limit value, it becomes difficult to obtain the effect of the air oxidation treatment or the activation treatment. When the interplanar distance of (002) planes of a graphite crystallite and the crystallite size of a graphite crystallite in a c-axis direction are within the above ranges, sufficient crystallinity is obtained, the electrode has high strength, and carbon particles of the plate-shaped carbonized product are less likely to flow into the electrolyte solution. The interplanar distance of (002) planes of a graphite crystallite in the plate-shaped carbonized product is determined from the distance between the (002) planes in the diffraction pattern obtained by an X-ray diffraction (XRD) measurement. The crystallite size of a graphite crystallite in a c-axis direction in the plate-shaped carbonized product can be determined from the X-ray diffraction data using the Scherrer's formula: D=Kλ/β cos θ. Here, D is the crystallite diameter (nm), λ is the wavelength of the X-ray tube (1.5418 Å of Cu-Kα ray), β is the spread of the diffracted X-ray due to the crystallite, θ is the diffraction angle (rad) with respect to the (002) plane, and K is the Scherrer constant and is 0.9. In the XRD measurement, a powder X-ray diffractometer (Rint2100 manufactured by Rigaku Corporation) using a Ni filter and CuKα ray is used.

The electrode for a redox flow battery of each of the first and second embodiments having the above properties can reduce the pressure drop at the time of supplying the electrolyte solution, and promotes the transport of the active material. Further, the electrode has a large BET specific surface area and a low kinetic (reaction) resistance. As a result, the electrode has high activity with respect to charging and discharging of the battery, and can improve the current output at the power transmission end of the redox flow battery, that is, the maximum power density of the battery.

### EXAMPLES

Hereinafter, Examples of the invention are explained in detail together with Comparative Examples.

### Example 1

First, a phenol resin and a PVA was mixed at a solid content ratio (phenol resin : PVA) of 3:1 so that the total mass of the solid contents was 30 w/v % of a predetermined amount to prepare an aqueous solution. Next, 4 w/v % of rice starch was added to the aqueous solution and mixed sufficiently, and then 5 w/v % of a 37 wt% formaldehyde aqueous solution was added as a cross-linking agent and mixed. Subsequently, 7 w/v % of maleic acid was added as a curing catalyst, and then water was added to a predetermined amount and mixed uniformly to obtain a reaction liquid. The obtained reaction liquid was cast into a mold and reacted at 60° C. for 20 hours. The obtained reaction product was taken out from the mold, and washed with water to remove the starch, and then dried. By this production method, a block of a porous phenol resin was obtained in which consecutive macropores having a porosity of 75% and an average macropore diameter of 27 μm were formed in a three-dimensional network form.

The block of the porous phenol resin was cut with a diamond saw to obtain a plate-shaped body having a length of 26 mm, a width of 26 mm, and a thickness of 0.53 mm. The plate-shaped body was heated from room temperature to 800° C. at a temperature rise rate of 5° C./min under a nitrogen gas atmosphere, and held at 800° C. for 1 hour under the nitrogen atmosphere to carry out a carbonization treatment to obtain a plate-shaped carbonized product. Next, the plate-shaped carbonized product was heated from room temperature to 1500° C. under an argon (Ar) atmosphere at a temperature rise rate of 5° C./min, and then held at 1500° C. for 1 hour under the argon atmosphere to carry out a high-temperature heat treatment to obtain a plate-shaped carbonized product having a length of 18.4 mm, a width of 18.4 mm, and a thickness of 0.43 mm. Finally, an air oxidation treatment is carried out at a temperature of 420° C. for 3 hours in a muffle furnace to obtain a plate-shaped carbonized product having a length of 18 mm, a width of 18 mm, and a thickness of 0.41 mm. The thickness of the above plate-shaped carbonized product was measured using a micrometer.

The following Table 1 shows the production conditions for the finally obtained plate-shaped carbonized products in Example 1, and Examples 2 to 12 and Comparative Examples 1 to 7 described below: (i) the average macropore diameter of the precursor, the thickness, the number of stacked plates, and (ii) the atmosphere, the temperature, and the time for each of the carbonization treatment, the high-temperature heat treatment, the air oxidation treatment, and the carbon dioxide activation treatment.

TABLE 1

| | Production conditions for plate-shaped carbon electrode material/carbon paper | | | | | | | | |
|---|---|---|---|---|---|---|---|---|---|
| | | Carbon material before | | | | | | | |
| | Average | high-temperature heat | | | | | | | |
| | macropore | treatment | | | | | | | |
| | diameter of | | Number | Carbonization treatment | | | High-temperature heat treatment | | |
| | Precursor | Thickness | of stacked | | Temperature | Time | | Temperature | Time |
| | (μm) | (mm/plate) | plates | Atmosphere | (° C.) | (hr) | Atmosphere | (° C.) | (hr) |
| Example 1 | 27 | 0.43 | 1 | N₂ | 800 | 1 | Ar | 1500 | 1 |
| Example 2 | 27 | 0.43 | 1 | N₂ | 800 | 1 | Ar | 2000 | 1 |
| Example 3 | 27 | 0.79 | 1 | N₂ | 800 | 1 | Ar | 2200 | 1 |
| Example 4 | 27 | 0.43 | 2 | N₂ | 800 | 1 | Ar | 1500 | 1 |
| Example 5 | 27 | 0.43 | 1 | N₂ | 800 | 1 | Ar | 1500 | 1 |
| Example 6 | 27 | 0.43 | 2 | N₂ | 800 | 1 | Ar | 2000 | 1 |
| Example 7 | 14 | 0.43 | 1 | N₂ | 800 | 1 | Ar | 1500 | 1 |
| Example 8 | 43 | 0.78 | 1 | N₂ | 800 | 1 | Ar | 1500 | 1 |
| Example 9 | 27 | 0.44 | 1 | N₂ | 800 | 1 | Ar | 1500 | 1 |
| Example 10 | 27 | 0.48 | 1 | N₂ | 800 | 1 | Ar | 1200 | 1 |
| Example 11 | 27 | 0.43 | 1 | N₂ | 800 | 1 | Ar | 1500 | 1 |
| Example 12 | 27 | 0.43 | 1 | N₂ | 800 | 1 | Ar | 1500 | 1 |
| Comparative | 27 | 0.43 | 2 | N₂ | 800 | 1 | — | — | — |
| Example 1 | | | | | | | | | |
| Comparative | 27 | 0.43 | 1 | N₂ | 800 | 1 | Ar | 1500 | 1 |
| Example 2 | | | | | | | | | |
| Comparison | — | 0.317 | 5 | — | — | — | — | — | — |
| Example 3 | | | | | | | | | |
| Comparative | — | 0.178 | 3 | — | — | — | — | — | — |
| Example 4 | | | | | | | | | |
| Comparative | — | 0.174 | 3 | — | — | — | — | — | — |
| Example 5 | | | | | | | | | |
| Comparative | 7 | 0.40 | 1 | N₂ | 800 | 1 | Ar | 1500 | 1 |
| Example 6 | | | | | | | | | |
| Comparative | 58 | 0.43 | 1 | N₂ | 800 | 1 | Ar | 1500 | 1 |
| Example 7 | | | | | | | | | |

| | Production conditions for plate-shaped carbon electrode material/carbon paper | | | | | |
|---|---|---|---|---|---|---|
| | Air oxidation treatment | | | Activation treatment | | |
| | | Temperature | Time | | Temperature | Time |
| | Atmosphere | (° C.) | (hr) | Atmosphere | (° C.) | (hr) |
| Example 1 | air | 420 | 3 | — | — | — |
| Example 2 | air | 500 | 3 | — | — | — |
| Example 3 | air | 500 | 3 | — | — | — |
| Example 4 | air | 420 | 3 | — | — | — |
| Example 5 | — | — | — | CO₂ | 900 | 1.5 |
| Example 6 | air | 500 | 3 | — | — | — |
| Example 7 | air | 420 | 3 | — | — | — |
| Example 8 | air | 420 | 3 | — | — | — |
| Example 9 | — | — | — | CO₂ | 900 | 2.5 |
| Example 10 | air | 400 | 3 | — | — | — |
| Example 11 | air | 420 | 4 | — | — | — |
| Example 12 | air | 420 | 4 | — | — | — |
| Comparative | air | 400 | 1 | — | — | — |
| Example 1 | | | | | | |
| Comparative | — | — | — | — | — | — |
| Example 2 | | | | | | |
| Comparison | air | 400 | 24 | — | — | — |
| Example 3 | | | | | | |
| Comparative | air | 650 | 3 | — | — | — |
| Example 4 | | | | | | |
| Comparative | air | 630 | 3 | — | — | — |
| Example 5 | | | | | | |
| Comparative | air | 420 | 3 | — | — | — |
| Example 6 | | | | | | |
| Comparative | air | 420 | 3 | — | — | — |
| Example 7 | | | | | | |

### Examples 2 to 12 and Comparative Examples 1 to 2 and 6 to 7

Final plate-shaped carbonized products were produced in Examples 2 to 12 and Comparative Examples 1 to 2 and 6 to 7, in which (i) the average macropore diameter of the carbon material before the carbonization treatment, the thickness, the number of stacked plates, and (ii) the atmosphere, the temperature, and the time of each of the carbonization treatment, the high-temperature heat treatment, the air oxidation treatment, and the carbon dioxide activation treatment were respectively the same as or changed from those of Example 1, as shown in Table 1. In these cases, the same operations as in Example 1 were carried out except that a carbon material before the high-temperature heat treatment having a thickness of 0.79 mm was used in Example 3 and a carbon material before the high-temperature heat treatment having a thickness of 0.78 mm was used in Example 8. Examples 1 to 4, 6 to 8, and 10 to 12, and Comparative Examples 6 to 7 were examples in which the air oxidation treatment was carried out as the final treatment, and Examples 5 and 9 were examples in which the carbon dioxide activation treatment was carried out as the final treatment. Further, in Example 6, two plate-shaped carbonized products produced in Example 2 were stacked. Comparative Example 1 was an example in which only the carbonization treatment and the air oxidation treatment were carried out.

### Comparative Example 1

Comparative Example 1 was carried out under the same conditions as in Example 6, except that the high-temperature heat treatment was not carried out and the air oxidation treatment was carried out at 400° C. for 1 hour.

### Comparative Example 2

Comparative Example 2 was carried out under the same conditions as in Example 1, except that the air oxidation treatment was not carried out.

### Comparative Example 3

As the carbon material, carbon paper having a thickness of 0.317 mm (manufactured by SGL Carbon Japan Ltd., trade name: SGL-10AA) was used. This carbon paper was heat-treated at 400° C. for 24 hours under a nitrogen gas atmosphere to carry out activation (air oxidation). Five activated carbon papers were stacked to obtain a plate-shaped carbonized product.

### Comparative Example 4

As the carbon material, carbon cloth having a thickness of 0.178 mm (manufactured by ElectroChem, trade name: EC-CC1-060) was used. This carbon cloth was heat-treated at 650° C. for 3 hours under a nitrogen gas atmosphere to carry out activation (air oxidation). Three activated carbon cloths were stacked to obtain a plate-shaped carbonized product.

### Comparative Example 5

As the carbon material, carbon paper having a thickness of 0.174 mm (manufactured by Toray Industries, Inc., trade name: TGP-H-60) was used. This carbon paper was heat-treated at 630° C. for 3 hours under a nitrogen gas atmosphere to carry out activation (air oxidation). Three activated carbon papers were stacked to obtain a plate-shaped carbonized product.

<Comparative Test and Evaluation>

The physical properties of the plate-shaped carbonized product as the electrode for the redox flow battery finally obtained in each of Examples 1 to 12 and Comparative Examples 1 to 7 were measured. The average macropore diameter, thickness, micropore volume, BET specific surface area, interplanar distance of (002) planes, and crystallite diameter were measured by the methods described above. The presence of uniformity of the macropores, and the presence of consecutive macropores, of the plate-shaped carbonized product, the pressure drop at the time of supplying the electrolyte solution by the power pump, and the maximum power density were measured by the following methods. The results thereof are shown in Table 2 below.

TABLE 2

| | Plate-shaped carbon electrode material/carbon paper | | | | | |
|---|---|---|---|---|---|---|
| | | Average | | | | |
| | | macropore | | | | |
| | Average | diameter of | | | | |
| | macropore | plate-shaped | | Presence of | Presence of | BET specific |
| | diameter of | carbon electrode | Thickness | uniformity of | consecutive | surface area |
| | precursor (μm) | material (μm) | (mm/plate) | macropores | macropores | (m²/g) |
| Example 1 | 27 | 13 | 0.41 | Yes | Yes | 640 |
| Example 2 | 27 | — | 0.42 | Yes | Yes | — |
| Example 3 | 27 | — | 0.67 | Yes | Yes | — |
| Example 4 | 27 | 13 | 0.41 | Yes | Yes | 640 |
| Example 5 | 27 | — | 0.41 | Yes | Yes | 855 |
| Example 6 | 27 | — | 0.42 | Yes | Yes | — |
| Example 7 | 14 | — | 0.42 | Yes | Yes | 740 |
| Example 8 | 43 | 30 | 0.75 | Yes | Yes | — |
| Example 9 | 27 | — | 0.43 | Yes | Yes | 850 |
| Example 10 | 27 | — | 0.47 | Yes | Yes | 820 |
| Example 11 | 27 | — | 0.42 | Yes | Yes | — |
| Example 12 | 27 | 13 | 0.41 | Yes | Yes | — |
| Comparative | 27 | 16 | 0.40 | Yes | Yes | 620 |
| Example 1 | | | | | | |
| Comparative | 27 | 13 | 0.42 | Yes | Yes | 12 |
| Example 2 | | | | | | |
| Comparative | — | — | 0.32 | — | — | — |
| Example 3 | | | | | | |
| Comparative | — | — | 0.18 | — | — | — |
| Example 4 | | | | | | |
| Comparative | — | — | 0.17 | — | — | — |
| Example 5 | | | | | | |
| Comparative | 7 | 4.7 | 0.39 | Yes | Yes | — |
| Example 6 | | | | | | |
| Comparative | 58 | 46 | 0.39 | Yes | Yes | — |
| Example 7 | | | | | | |

| | Plate-shaped carbon electrode material/carbon paper | | | | | |
|---|---|---|---|---|---|---|
| | | | Crystallite | | | |
| | | Interplanar | size in | Flow rate of | | Maximum |
| | Micropore | distance of | c-axis | electrolyte | | power |
| | volume | (002) planes | direction | solution | Pressure | density |
| | (ml/g) | (nm) | (nm) | (mL/min) | drop (kPa) | (W/cm²) |
| Example 1 | 0.25 | 0.36 | 1.0 | 14 | 28 | 0.69 |
| Example 2 | — | 0.35 | 4.2 | 20 | 13 | 0.84 |
| Example 3 | — | 0.34 | 8.1 | 20 | 21 | 0.88 |
| Example 4 | 0.25 | 0.36 | 1.0 | 20 | 11 | 0.85 |
| Example 5 | 0.37 | 0.36 | 1.0 | 20 | 30 | 0.81 |
| Example 6 | — | 0.35 | 4.2 | 20 | 13 | 0.87 |
| Example 7 | 0.31 | — | — | 20 | 13.7 | 0.71 |
| Example 8 | — | 0.39 | 1.0 | 20 | 7.0 | 0.63 |
| Example 9 | 0.33 | 0.39 | 0.98 | 20 | 24.5 | 0.69 |
| Example 10 | 0.32 | 0.39 | 1.0 | 20 | 15.0 | 0.63 |
| Example 11 | — | — | — | 20 | 13.2 | 0.70 |
| Example 12 | — | — | — | 20 | 13.0 | 0.65 |
| Comparative | 0.25 | 0.41 | 0.8 | 20 | 17 | 0.27 |
| Example 1 | | | | | | |
| Comparative | <0.01 | 0.36 | 1.0 | 20 | 14 | 0.50 |
| Example 2 | | | | | | |
| Comparative | — | — | — | 20 | 15 | 0.36 |
| Example 3 | | | | | | |
| Comparative | — | 0.35 | 2.4 | 20 | 7 | 0.59 |
| Example 4 | | | | | | |
| Comparative | — | 0.34 | 39 | 20 | 11 | 0.58 |
| Example 5 | | | | | | |
| Comparative | — | — | — | 14 | 83.3 | 0.87 |
| Example 6 | | | | | | |
| Comparative | — | — | — | 20 | 4.5 | 0.53 |
| Example 7 | | | | | | |

(Presence of Uniformity of Macropores and Presence of Consecutive Macropores in Plate-Shaped Carbonized Product)

Surface observation was carried out on the plate-shaped carbonized product using a scanning electron microscope (SEM) (JSM-6700F manufactured by JEOL Ltd.). A case in which the macropores were uniform is indicated as “Yes”, and a case in which the macropores were not uniform is indicated as “No”. Further, using the same microscope, it was examined whether or not the macropores of the plate-shaped carbonized product were consecutive. A case in which the macropores were consecutive is indicated as “Yes”, and a case in which the macropores were not consecutive is indicated as “No”.

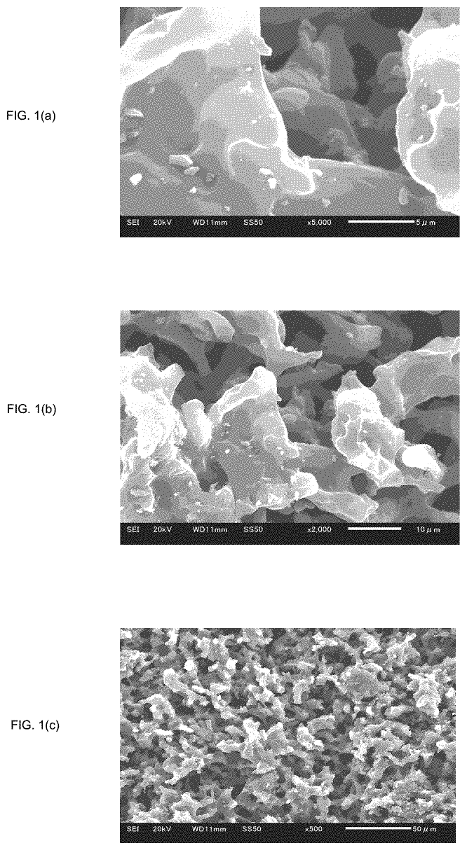

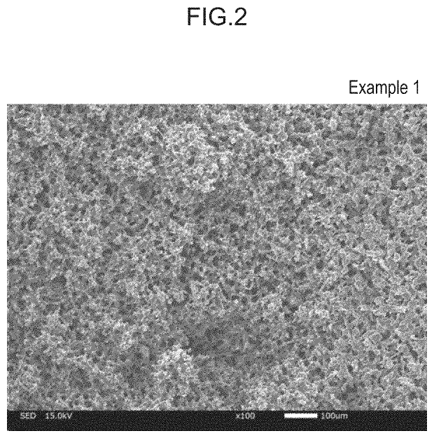

FIG. 1 shows scanning electron microscope (SEM) images of the plate-shaped carbonized product of Example 1. FIG. 1(a) is an image at a magnification of 5,000 times, FIG. 1(b) is an image at a magnification of 2,000 times, and FIG. 1(c) is an image at a magnification of 500 times. From these SEM images, it was confirmed that the shapes of the macropores were the same and uniform in the thickness direction and the in-plane direction of the plate-shaped carbonized product. FIG. 2 shows a SEM image of the porous phenol resin of Example 1. From these images, it was confirmed that the plate-shaped carbonized product had uniform consecutive macropores.

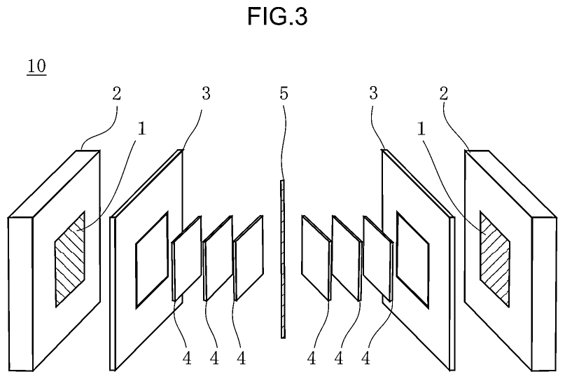

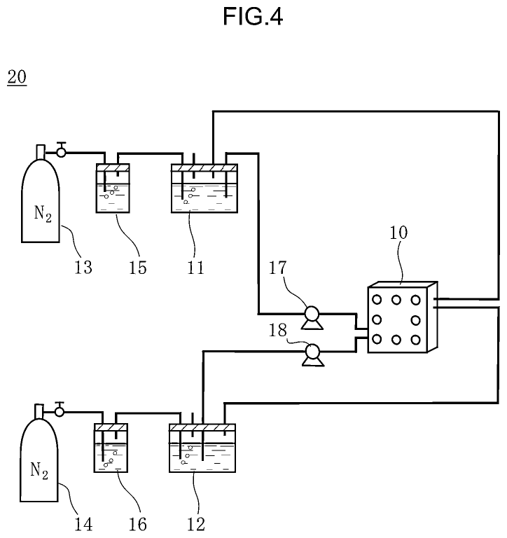

Next, the pressure drop and the maximum power density of the plate-shaped carbonized product as the electrode for the redox flow battery were measured using a redox flow battery system and an electrochemical measurement system as shown in FIG. 4 after assembling a cell including the plate-shaped carbonized products as electrodes as shown in FIG. 3.

(Production of Single Redox Flow Battery)

As shown in FIG. 3, the single redox flow battery cell 10 included a carbon block 2 (current collector) provided with an interdigitated flow channel 1, a gasket 3, plate-shaped carbon electrode materials 4, and a separator 5 (Nafion 117 manufactured by Dupont), in this order from the outside. The plate-shaped carbon electrode material 4 was adjusted with the gasket so as to have a thickness that was 75% of the original thickness, in which the tightening torque was 1 Nm. The plate-shaped carbon electrode material 4 had an electrode area of 3.24 cm².

(Preparation of Electrolyte Solution)

A 1.0 M vanadium ion (V ion)+3.0 M H₂SO₄ solution was used as the electrolyte solution for I-V measurement. This electrolyte solution was prepared by mixing 354.12 g of concentrated sulfuric acid (95%) with distilled water to prepare 1.0 L of a 3.43 M H₂SO₄ aqueous solution, followed by adding, to 41 mL of this solution, 59 mL of a 1.7 Vion+3.0 M H₂SO₄ solution (manufactured by LE System Co., Ltd.). 100 mL of 1M V(V)+3M H₂SO₄ solution was used as the positive electrolyte solution, and 100 mL of 1M V(II)+3M H₂SO₄ solution was used as the negative electrolyte solution.

(Electrolysis of Electrolyte Solution)

As shown in FIG. 4, the redox flow battery system 20 included a single redox flow battery cell 10, a positive electrode electrolyte solution tank 11 and a negative electrode electrolyte solution tank 12 for the battery cell, containers 13 and 14 containing a nitrogen (N₂) gas, bubblers 15 and 16, and pumps 17 and 18. 100 mL of each of the positive electrolyte solution and the negative electrolyte solution was put into each of the electrolyte solution tanks 11 and 12, and then, in order to remove O₂ of the electrode cell and the electrolyte solutions, humidified N₂ gas was constantly flowed into the electrolyte solutions of the tanks 11 and 12 at a flow rate of 20 mL/min from the containers 13 and 14 via the bubblers 15 and 16. Further, the electrolyte solutions in the tanks 11 and 12 were circulated through the pumps 17 and 18 to the single redox flow battery cell 10 at a flow rate as shown in Table 2. The negative electrode and the positive electrode in the single redox flow battery cell 10 were connected to a charge/discharge test device (PFX2011 manufactured by Kikusui Electronics Corporation) (not shown in the figure). 200 mA/cm² of a constant current was applied to the single redox flow battery cell 10 to carry out constant current charging until the voltage exceeded 1.8 V, and then a constant voltage charging was carried out at 1.8 V until the current became 20 mA or less (state of charge=SOC 99%), whereby the electrolyte solution was electrolyzed.

(Measurement of Current Voltage (I-V))

I-V measurement in the redox flow battery system, in which the charged electrolyte solution was circulated, was carried out by using an electrochemical measurement system (HZ-5000 manufactured by Hokuto Denko Corporation), dropping the voltage from the open circuit voltage (OCV) at a constant rate (2 mV/s), and measuring the current value at that time. At the same time, the liquid pressure at the cell inlet was measured using a pressure transmitter. The cell outlet was at atmospheric pressure, and the pressure drop was measured from the difference between the cell inlet pressure and the cell outlet pressure.

(Maximum Power Density of Battery)

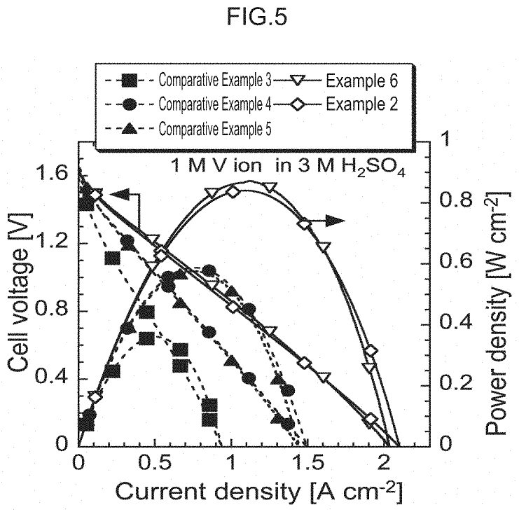

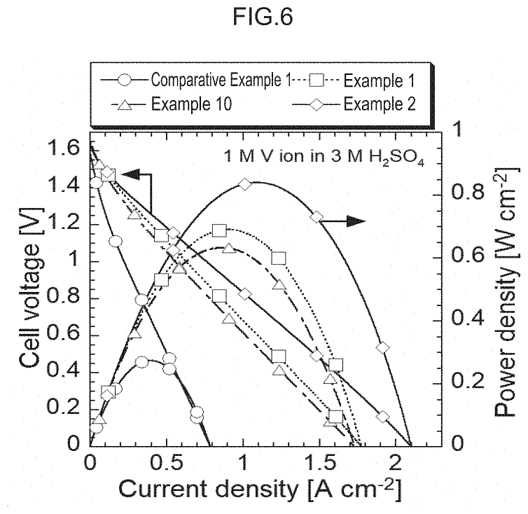

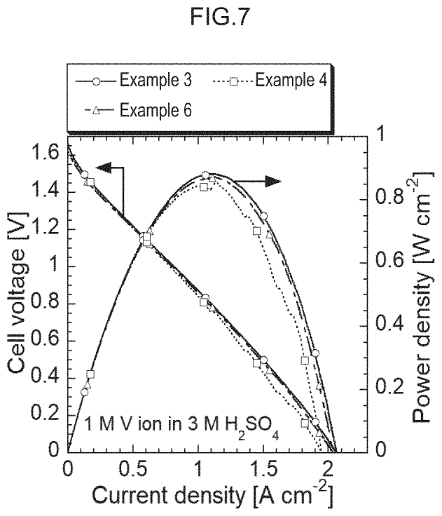

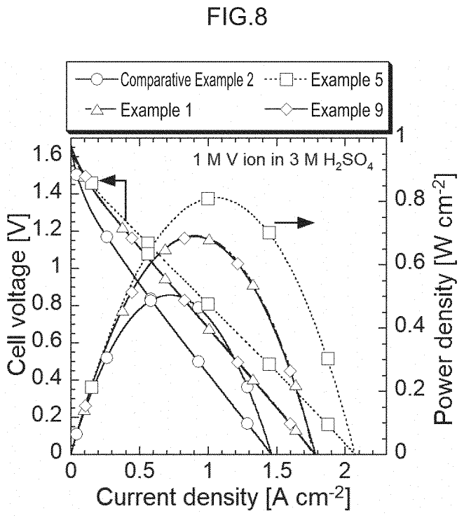

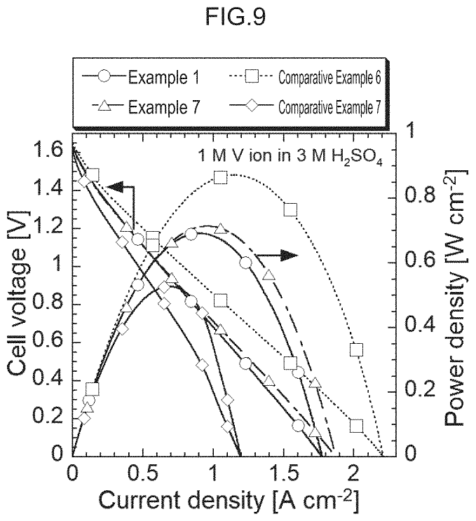

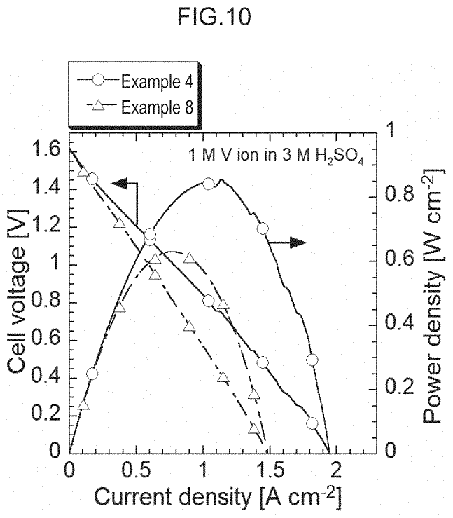

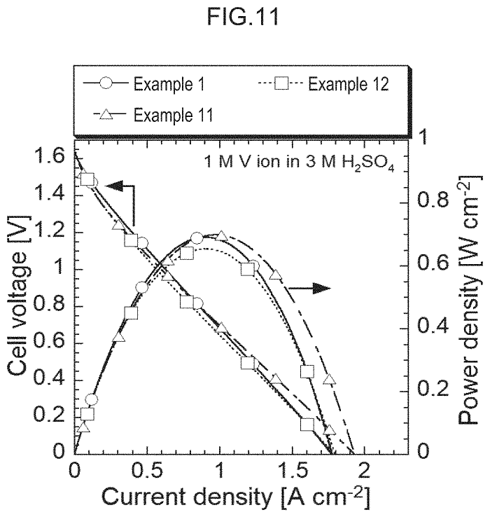

The maximum power density of the battery was determined from the current value and the voltage value obtained by the measurement of the current voltage (I-V). Specifically, the maximum power density was determined from the peak value of the power curve shown together with the current-voltage curve of the battery. The maximum power densities were determined from the current-voltage curves and the power curves of the batteries using the plate-shaped carbon electrode materials of Examples 2 and 6 and the batteries using the carbon paper or the carbon cloth of Comparative Examples 3 to 5 as shown in FIG. 5. Similarly, the maximum power densities of the batteries using the plate-shaped carbon electrode materials of Examples 1, 2, and 10, and Comparative Example 1 were determined from FIG. 6, the maximum power densities of the batteries using the plate-shaped carbon electrode materials of Examples 3, 4, and 6 were determined from FIG. 7, the maximum power densities of the batteries using the plate-shaped carbon electrode materials of Examples 1, 5, and 9, and Comparative Example 2 were determined from FIG. 8, the maximum power densities of the batteries using the plate-shaped carbon electrode materials of Examples 1 and 7, and Comparative Examples 6 and 7 were determined from FIG. 9, the maximum power densities of the batteries using the plate-shaped carbon electrode materials of Examples 4 and 8 were determined from FIG. 10, and the maximum power densities of the batteries using the plate-shaped carbon electrode materials of Examples 1, 11, and 12 were determined from FIG. 11.

As is clear from Table 2, since the plate-shaped carbon electrode material of Comparative Example 1 had been subjected to only a carbonization treatment and an air oxidation treatment, but had not been subjected to a high-temperature heat treatment, the maximum power density was low (0.27/cm²). Further, since the plate-shaped carbon electrode material of Comparative Example 2 had been subjected to only a carbonization treatment and a high-temperature heat treatment, but had not been subjected to an air oxidation treatment, the maximum power density was low (0.50/cm²).

Further, since the carbon paper or the carbon cloth of Comparative Examples 3 to 5 was composed of a stacked material in which carbon fibers or carbon cloths were stacked, although the pressure drop at the time of supplying the electrolyte solution was low (15 kPa, 7 kPa, or 11 kPa), the maximum power densities of Comparative Examples 3 to 5 were low (from 0.36 W/cm² to 0.59 W/cm²). From these results, it has been found that the plate-shaped carbon electrode materials of Comparative Examples 1 and 2 and the carbon paper and the carbon cloth of Comparative Examples 3 to 5 cannot simultaneously satisfy the two requirements of a small pressure drop and a high maximum power density that are required for electrodes for redox flow batteries, and cannot be used as electrodes for redox flow batteries.

Further, since the plate-shaped carbon electrode material of Comparative Example 6 had a small macropore diameter, although the maximum power density was high (0.87 W/cm²), the pressure drop was large (83.3 kPa). Further, since the plate-shaped carbon electrode material of Comparative Example 7 had a large macropore diameter, the maximum power density was low (0.53 W/cm²) and the pressure drop was small (4.5 kPa).

In contrast, as is clear from Table 2, since the plate-shaped carbon electrode materials of Examples 1 to 12 had the characteristics of the first aspect of the invention, and were produced under the conditions of the second or third aspect, the pressure drop at the time of supplying the electrolyte solution was small (from 7 kPa to 30 kPa), and the maximum power density was high (from 0.63 W/cm² to 0.88 W/cm²). From these results, it has been found that the plate-shaped carbon electrode materials of Examples 1 to 12 have a small pressure drop and a high maximum power density, and are suitable as electrodes for redox flow batteries.

In the evaluations of the Examples and the Comparative Examples, the BET specific surface areas were compared according to the difference in the treatment methods. The BET specific surface area of the plate-shaped carbonized product of Comparative Example 2 which had been subjected to only a carbonization treatment and a high-temperature heat treatment was 12 m²/g, and the BET specific surface area of the plate-shaped carbonized product of Comparative Example 1 which had been subjected to a carbonization treatment but had not been subjected to a high-temperature heat treatment was 620 m²/g, whereas the BET specific surface area of the plate-shaped carbon electrode material of Example 5 was 855 m²/g, the BET specific surface area of Example 1 was 640 m²/g, the BET specific surface area of Example 4 was 640 m²/g, the BET specific surface area of Example 7 was 740 m²/g, the BET specific surface area of Example 9 was 850 m²/g, and the BET specific surface area of Example 10 was 820 m²/g.

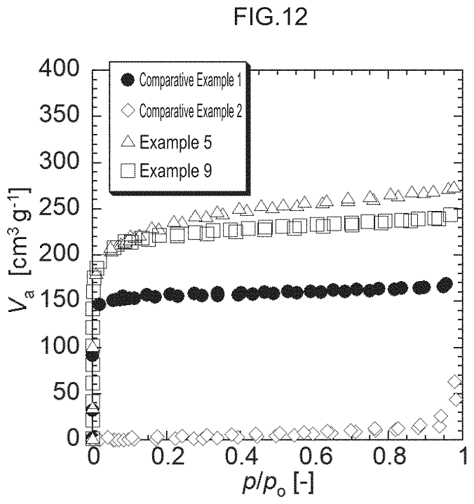

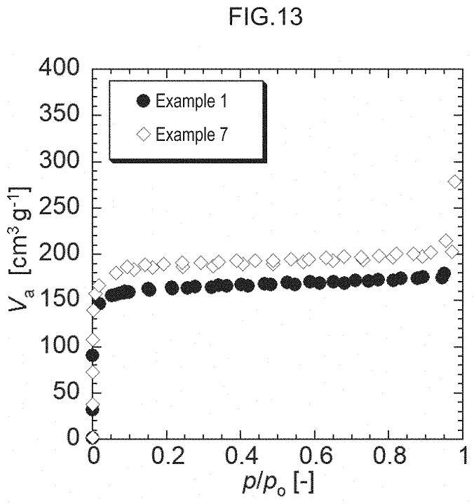

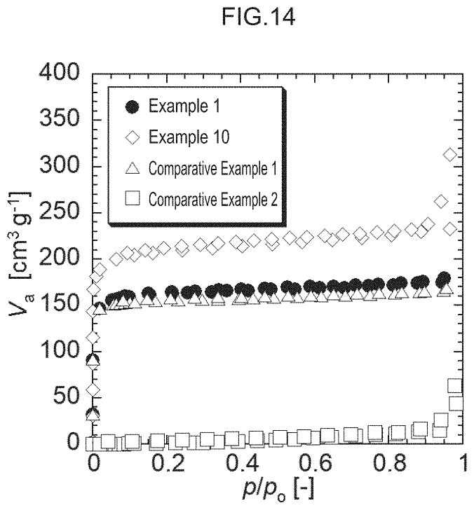

The reason why the BET specific surface areas of Examples 5 and 9 were increased can be explained as follows from the difference in nitrogen adsorption amount in the nitrogen adsorption desorption isotherms as shown in FIG. 12. As shown in FIG. 12, at the time of the carbonization treatment at 800° C., carbon crystallization is insufficient and carbon is irregularly accumulated, and the BET specific surface area is increased to some extent. However, after that, by carrying out the high-temperature heat treatment at 1500° C., the crystallinity is improved and the BET specific surface area is once reduced. It is considered that by further carrying out the carbon dioxide activation treatment of Examples 5 and 9 in that state, micropores are developed in the carbonized product, and the BET specific surface area is increased. The reason why the BET specific surface areas of Example 1, 4, 7, and 10 were increased can be explained as follows from the difference in nitrogen adsorption amount in the nitrogen adsorption desorption isotherms as shown in FIGS. 13 and 14. As shown in FIG. 14, at the time of the carbonization treatment at 800° C., carbon crystallization is insufficient and carbon is irregularly accumulated, and the BET specific surface area is increased to some extent. However, after that, by carrying out the high-temperature heat treatment at 1500° C., the crystallinity is improved, and the surface area is once reduced. It is considered that by further carrying out the air oxidation treatment of Examples 1 to 4, 6 to 8, and 10 to 12 in that state, micropores are developed in the carbonized product, and the BET specific surface area is increased.

### INDUSTRIAL APPLICABILITY

The plate-shaped carbon electrode material of the invention is used as an electrode for a redox flow battery.

1. An electrode for a redox flow battery, comprising one plate-shaped carbon electrode material or two or more stacked plate-shaped carbon electrode materials, in which uniform consecutive macropores are formed in a three-dimensional network form and contact interface between carbon particles does not exist, wherein:
an average macropore diameter of the carbon electrode material is in a range of from 6 μm to 35 μm;
an interplanar distance of (002) planes of a graphite crystallite in the carbon electrode material is in a range of from 0.33 nm to 0.40 nm;
a crystallite size of a graphite crystallite in a c-axis direction in the carbon electrode material is in a range of from 0.9 nm to 8.5 nm; and
a thickness of the electrode is in a range of from 0.4 mm to 0.8 mm.

2. The electrode for a redox flow battery according to claim 1, wherein:
a BET specific surface area of the carbon electrode material according to a nitrogen adsorption method at 77 K is in a range of from 100 m²/g to 1,500 m²/g; and
a micropore volume of the carbon electrode material is in a range of from 0.05 ml/g to 0.70 ml/g.

3. A method of producing an electrode for a redox flow battery, the method comprising:
cutting a block of a porous phenol resin, in which uniform consecutive macropores having an average macropore diameter in a range of from 4 μm to 70 μm are formed in a three-dimensional network form, into a plate-shaped body;
raising a temperature of the plate-shaped body from room temperature to a range of from 800° C. to 1,000° C. under an inert gas atmosphere, and carrying out a carbonization treatment by keeping a treatment temperature of the plate-shaped body at the raised temperature under an inert gas atmosphere, thereby obtaining a plate-shaped carbonized product;
raising a temperature of the plate-shaped carbonized product from room temperature to a range of from 1,100° C. to 2,500° C., and carrying out a high-temperature heat treatment by keeping a treatment temperature of the plate-shaped carbonized product at the raised temperature under an inert gas atmosphere; and
raising a temperature of the plate-shaped carbonized product, on which the high-temperature heat treatment has been carried out, from room temperature to a range of from 350° C. to 600° C. in air, and carrying out an air oxidation treatment by keeping a treatment temperature of the plate-shaped carbonized product at the raised temperature in air, thereby obtaining a plate-shaped carbon electrode material.

4. A method of producing an electrode for a redox flow battery, the method comprising:
cutting a block of a porous phenol resin, in which uniform consecutive macropores having an average macropore diameter in a range of from 4 μm to 70 μm are formed in a three-dimensional network form, into a plate-shaped body;
raising a temperature of the plate-shaped body from room temperature to a range of from 800° C. to 1,000° C. under an inert gas atmosphere, and carrying out a carbonization treatment by keeping a treatment temperature of the plate-shaped body at the raised temperature under an inert gas atmosphere, thereby obtaining a plate-shaped carbonized product;
raising a temperature of the plate-shaped carbonized product from room temperature to a range of from 1,100° C. to 2,500° C., and carrying out a high-temperature heat treatment by keeping a treatment temperature of the plate-shaped carbonized product at the raised temperature under an inert gas atmosphere; and
carrying out an activation treatment on the plate-shaped carbonized product, on which the high-temperature heat treatment has been carried out, so that an activation yield is in a range of from 50% to 90%, thereby obtaining a plate-shaped carbon electrode material.

5. The method of producing an electrode for a redox flow battery according to claim 4, wherein the activation treatment is carried out by raising a temperature of the plate-shaped carbonized product, on which the high-temperature heat treatment has been carried out, from room temperature to a range of from 800° C. to 1,000° C. under an inert gas atmosphere, and keeping a treatment temperature of the plate-shaped carbonized product at the raised temperature under a carbon dioxide gas flow.

6. A redox flow battery using the electrode according to claim 1.

7. A redox flow battery using the electrode according to claim 2.
